(19) United States
(12) Patent Application Publication
(10) Pub. No.: US 2017/0118583 A1
(43) Pub. Date: Apr. 27, 2017

(54) METHOD AND DEVICE FOR CONTROLLING OF OPENING AND CLOSING AUTOMOBILE DOOR LOCK THROUGH BLUETOOTH TECHNOLOGY

(71) Applicants: LE HOLDINGS (BEIJING) CO., LTD., Beijing (CN); Lemobile Information Technology (Beijing) Co., Ltd, Beijing (CN)

(72) Inventors: Hailan YU, Beijing (CN); Qin HUANG, Beijing (CN)

(21) Appl. No.: 15/243,852

(22) Filed: Aug. 22, 2016

Related U.S. Application Data
(63) Continuation of application No. PCT/CN2016/087015, filed on Jun. 24, 2016.

(30) Foreign Application Priority Data
Oct. 22, 2015 (CN) 201510695694.X

(51) Int. Cl. H04W 4/00; H04L 12/26; H04W 4/06

(52) U.S. Cl. CPC H04W 4/008; H04W 4/06; H04L 43/16

(57) ABSTRACT

An embodiment of the present disclosure discloses a method and device for controlling of opening and closing an automobile door lock through a Bluetooth technology. The method comprises: receiving a UUID broadcast by a to-be-unlocked automobile door lock by a mobile terminal; configuring locking control services corresponding to the to-be-unlocked automobile door, characteristics of the locking control services, and configuration descriptors of the characteristics and establishing a Bluetooth connection with the to-be-unlocked automobile door according to the UUID; amending the configuration descriptors of the characteristics through the Bluetooth connection to open or close the to-be-unlocked automobile door. According to the present disclosure, a Bluetooth connection between the mobile terminal and the automobile door lock is established to amend the configuration descriptors of the characteristics so as to open or close die to-be-unlocked automobile door, and thus the car automobile door is opened without a metal key or a remote key.

### CROSS-REFERENCE TO RELATED APPLICATIONS

The present disclosure is a continuation of International Application No. PCT/CN2016/087015, filed on Jun. 24, 2016; which is based upon and claims priority to Chinese Patent Application No. 201510695694.X. entitled “METHOD AND DEVICE FOR CONTROLLING OF OPENING AND CLOSING AUTOMOBILE DOOR LOCK THROUGH BLUETOOTH TECHNOLOGY”, filed on Oct. 22, 2015. the entire contents of all of which are incorporated herein by reference.

### TECHNICAL FIELD

The present disclosure generally relates to the technical field of a remote control and particularly relates to a method and device for controlling of opening and closing an automobile door lock through Bluetooth technology.

### BACKGROUND

With development of the automobile manufacturing industry, the automobile is used as a transportation tool by increasing numbers of users; in order to meet users' demands on speed, safety and comfort level of the automobile, the automobile is also developing to in an intelligent direction.

The user preserves important articles or licenses, for example a driver's license and a driving license. In order to prevent the automobile or articles in the automobile from being stolen by other persons, an automobile lock is arranged on an automobile door. The early-stage automobile key is a metal sheet, and the user opens the automobile door and starts the engine by turning the key. Subsequently, a remote key is researched and regarded as a wireless signal source, an unlocking command is sent to the automobile by pressing an unlocking button on the remote key, and the automobile door lock is opened after the automobile receives the unlocking command; a locking command is sent to the automobile by pressing a locking button on the remote key, and the automobile door is locked after automobile receives the locking command. The automobile door cannot be opened when the metal key or the remote key is lost.

Therefore, at present a technical problem demanded for being urgently solved by a technician in the field is as follows: how to open the automobile door without adopting a metal key or a remote key.

### SUMMARY

An embodiment of the present disclosure provides a method and device for controlling of opening and closing die automobile door lock through Bluetooth technology, and the method and the device are used for solving the problem that the automobile door cannot be opened in the prior art no matter if the metal key or the remote key is lost.

According to one aspect of the present disclosure, the present disclosure discloses a method for controlling of opening and closing the automobile door lock through Bluetooth technology, and the method includes:

receiving a UUID broadcast by a to-be-unlocked automobile door lock, by a mobile terminal;

configuring locking control services corresponding to the to-be-unlocked automobile door, characteristics of the locking control services, and configuration descriptors of the characteristics, and establishing a Bluetooth connection with the to-be-unlocked automobile door, according to the UUID; and

amending the configuration descriptors of the characteristics through the Bluetooth connection to open or close the to-be-unlocked automobile door lock.

According to the other aspect of the present disclosure, the present disclosure further discloses an electronic device for controlling of opening and closing the automobile door lock through Bluetooth technology, and the device includes: at least one processor; and a memory communicably connected with the at least one processor for storing instructions executable by the at least one processor, wherein execution of the instructions by the at least one processor causes the at least one processor to:

receive the UUID broadcast by the to-be-unlocked automobile door lock;

configure locking control services corresponding to the to-be-unlocked automobile door, characteristics of the locking control services, and configuration descriptor of the characteristics, and establish a Bluetooth connection with the to-be-unlocked automobile door, according to the UUID; and

amend the configuration descriptors of the characteristics through the Bluetooth connection to open or close the to-be-unlocked automobile door lock.

According to still another aspect of the present disclosure, the present disclosure discloses a computer program, and the computer program includes a computer readable code; when the computer readable code is operated in an electronic device, the method for controlling of opening and closing the automobile door lock through Bluetooth technology is implemented by the electronic device.

According to one more aspect of the present disclosure, the present disclosure discloses a non-transitory computer readable medium having computer programs stored thereon that, when executed by one or more processors of an electronic device, cause the electronic device to perform operations including:

receiving a UUID broadcast by a to-be-unlocked automobile door lock, by a mobile terminal;

configuring locking control services corresponding to the to-be-unlocked automobile door, characteristics of the locking control services, and configuration descriptors of the characteristics, and establishing a Bluetooth connection with the to-be-unlocked automobile door, according to the UUID; and

amending the configuration descriptors of the characteristics through the Bluetooth connection to open or close the to-be-unlocked automobile door lock.

The present disclosure has the advantages in that:

by the method and device for controlling of opening and closing the automobile door lock through Bluetooth technology disclosed in the embodiment of the present disclosure, Bluetooth connection between the mobile terminal and the automobile door lock is established to amend the configuration descriptors of the characteristics to open or close the to-be-unlocked automobile door lock, and thus the automobile door can be opened without the metal key or the remote key.

The description is only the summary of the technical solution of the present disclosure; in order to clearly understand technical measures of the present disclosure, implement the measures according to the summary of the description, and make the above or other purposes, characteristics and advantages of the present disclosure be obvious and easy to understand, specific implementing ways of the present disclosure are especially described below.

### DETAILED DESCRIPTION

In order to clearly describe technical solutions in the embodiment of the present disclosure or the prior art, drawings used for description of the embodiment or the prior art are simply introduced; obviously, the drawings in tire following description are some embodiments of the present disclosure, ordinary technicians in the art can obtain other drawings according to the drawings without creative work.

FIG. 1 is a flow chart of steps of the method for controlling of opening and closing the automobile door lock through Bluetooth technology according to some embodiments of the present disclosure.

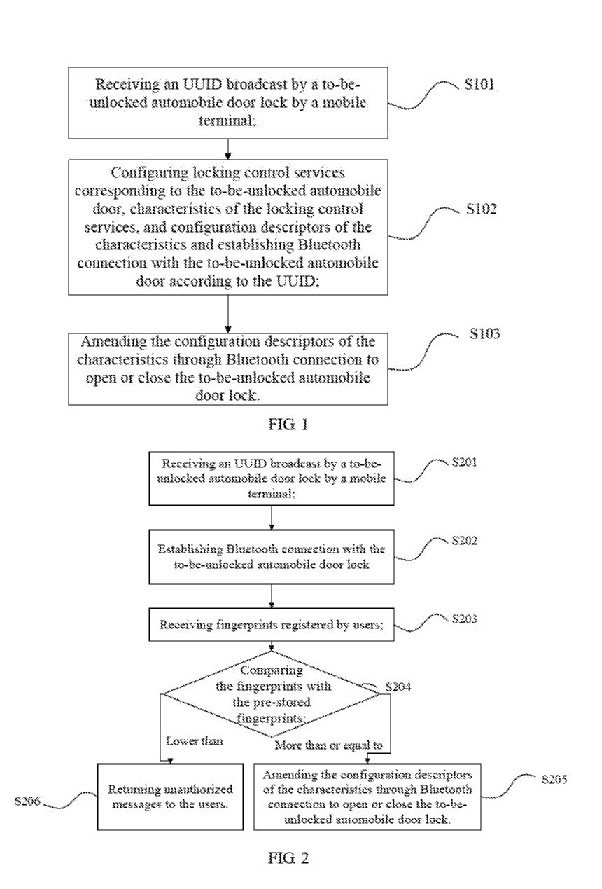

FIG. 2 is a flow chart of steps of the method for controlling of opening and closing the automobile door lock through Bluetooth technology according to some embodiments of the present disclosure.

FIG. 3 is a schematic diagram of a scene of establishing a Bluetooth connection between the mobile terminal and the automobile door lock according to some embodiments of the present disclosure.

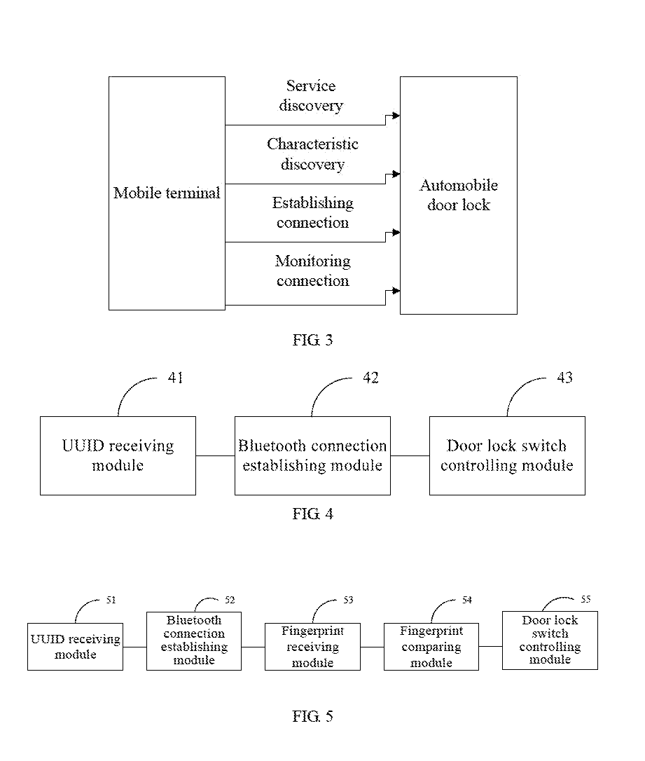

FIG. 4 is a structure diagram of the device for controlling of opening and closing tire automobile door lock through Bluetooth technology according to some embodiments of the present disclosure.

FIG. 5 is a structure diagram of the device for controlling of opening and closing the automobile door lock through Bluetooth technology according to some embodiments of the present disclosure.

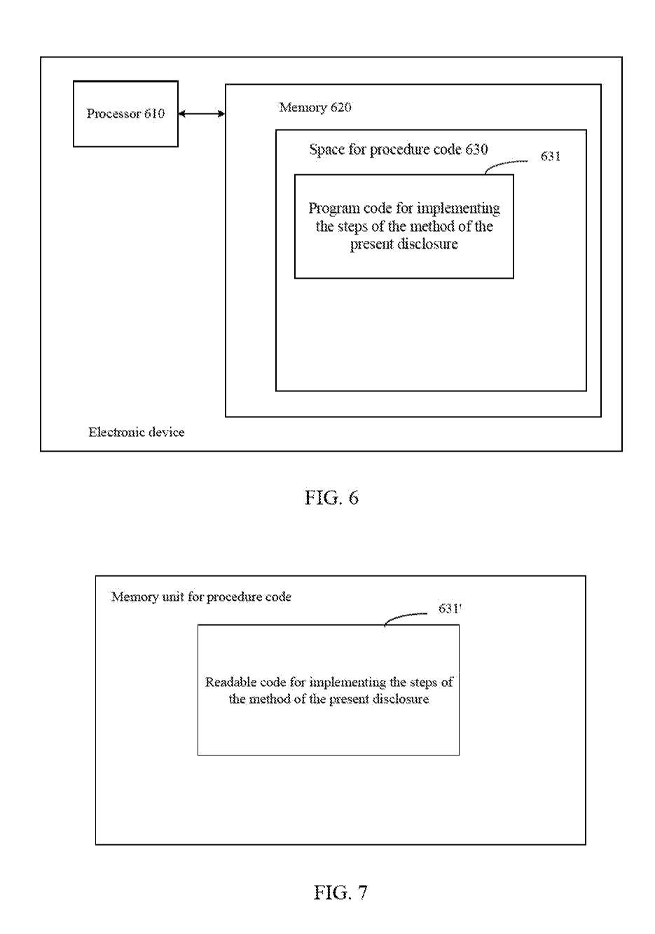

FIG. 6 schematically illustrates a block diagram of the electronic device used for implementing the method of the present disclosure.

FIG. 7 schematically illustrates a memory unit for storing or carrying the program code according to the method of the present disclosure.

### DESCRIPTION OF THE EMBODIMENTS

In order to make the purpose, the technical solution and the advantages in the embodiment of the present disclosure clear, the technical solution in the embodiment of the present disclosure is clearly and completely described according to the drawings; obviously, the described embodiments are only the partial embodiments instead of the entire embodiments. Based on the embodiments of the present disclosure, all other embodiments obtained by the ordinary technicians in the art in the absence of creative work are in the protective range of the present disclosure.

An SDP (Service Discovery Protocol) is regarded as the core protocol of a Bluetooth protocol system, the important constituent part of a Bluetooth system and the basis of all user modes. In the Bluetooth system, a client can acquire equipment information, service information and service characteristics only through the SDP, and then mutual connection is established on the basis. The SDP provides a method for discovering effective services and determines the characteristics of the effective services.

The SDP includes the following basic functions: providing a searching service function based on service attribute to the client, providing a discovering service function based on service class, providing a browsing service function, providing a determining mechanism of equipment effectiveness or service effectiveness, providing a determining mechanism of equipment invalidation or service invalidation, providing unique identification of service, service class and service attribution, and discovering the service on another equipment without being found by a third party; the SDP is applied to simple equipment and provides incremental-quantity acquiring service information mechanism and supports high-speed caching of service discover information and increase the discovery efficiency or speed of the process; the SDP is transmitted independently, utilizes L2CPA as a transport layer protocol, and discovers and uses other discovery service protocols; besides the SDP supports creation and definition of new service without admission of a primary device.

### First Embodiment

FIG. 1 shows that the embodiment of the present disclosure discloses a flow chart of steps of the method for controlling of opening and closing the automobile door lock through Bluetooth technology.

Based on the SDP technology, the embodiment discloses a method for controlling of opening and closing the automobile door lock through Bluetooth technology, and the method is shown in the FIG. 1 and includes the steps as follows.

Step S101, receiving a UUID (Universally Unique Identifier) broadcast by the to-be-unlocked automobile door lock, by a mobile terminal.

In the step, the mobile terminal includes clients such as a mobile phone, a tablet personal computer and a smart watch that have the Bluetooth function.

Step S102, configuring locking control services corresponding to the to-be-unlocked automobile door, characteristics of the locking control services, and configuration descriptors of the characteristics, and establishing a Bluetooth connection with the to-be-unlocked automobile door according to the UUID.

In the step, the mobile terminal implements service discovery through the SDP and discovers Link Loss Service and Tx power Service according to the received UUID. Characteristic descriptors of the service is discovered through Characteristic Discovery, and Light Control Characteristics are configured to the Link Loss.

Step S103, amending the configuration descriptors of the characteristics through the Bluetooth connection in order to open or close the to-be-locked automobile door lock.

In the step, the configuration descriptors of the characteristics include: An opening descriptor and a closing descriptor; the opening descriptor may indicate that the automobile lock is in the opening state, and the closing descriptor may indicate that the automobile lock is in the closing state. In the embodiment of the present disclosure, if the configuration descriptor of the present characteristic is the opening descriptor, the configuration descriptor of the characteristic is amended into the closing descriptor on the automobile through the Bluetooth connection to close the automobile door lock; if the configuration descriptor of the present characteristic is the closing descriptor, the configuration descriptor of the characteristic is amended into the opening descriptor on the automobile through the Bluetooth connection to open the automobile door lock.

By the method for controlling of opening and closing the automobile door lock through Bluetooth technology disclosed in the embodiment of the present disclosure, Bluetooth connection between the mobile terminal and the automobile door lock is established to amend the configuration descriptors of the characteristics to open or close the to-be-unlocked automobile door lock, and thus the automobile door can be opened without the metal key or the remote key.

### Second Embodiment

FIG. 2 shows that the embodiment of the present disclosure discloses a flow chart of steps of the method for controlling of opening and closing the automobile door lock through Bluetooth technology.

FIG. 3 shows a schematic diagram of a scene of establishing a Bluetooth connection between the mobile terminal and the automobile door lock in the embodiment of the present disclosure.

To prevent the automobile or articles in the automobile from being stolen by opening the automobile lock by persons excluding individual car owners, the present embodiment disclosures a method for controlling of opening and closing the automobile door lock through Bluetooth technology; as shown in FIG. 2, the method includes following steps as follows.

Step S201, receiving the UUID broadcast by the to-be-unlocked automobile door lock, by the mobile terminal.

Step S202, configuring locking control services corresponding to the to-be-unlocked automobile door, characteristics of the locking control services, and configuration descriptors of the characteristics, and establishing a Bluetooth connection with the to-be-unlocked automobile door, according to the UUID.

Step S203, receiving fingerprints registered by users.

Step S204, comparing the fingerprints with the pre-stored fingerprints;

In the step, the pre-stored fingerprints are the fingerprints pre-stored in the mobile terminal by the individual car owners. If the similarity of the fingerprints and the pre-stored fingerprints is more than or equal to the threshold, namely the users of inputting the fingerprints are the individual car owners, the Step S205 is implemented; if the similarity of the fingerprints and the pre-stored fingerprints is lower than the threshold, namely the users of inputting the fingerprints are not the individual car owners, the Step S206 is implemented.

Step S205, amending the configuration descriptors of the characteristics through the Bluetooth connection to open or close the to-be-unlocked automobile door lock.

Step S206, returning message of authentication failure to the users.

In the step, the message of authentication failure is returned through any one of voice prompt, vibration, buzzer driving and question hint displaying to prompt the failure of subscriber authentication.

By the method for controlling of opening and closing the automobile door lock through Bluetooth technology disclosed in the embodiment of the present disclosure, a Bluetooth connection between the mobile terminal and the automobile door lock is established to amend the configuration descriptors of the characteristics so as to open or close the automobile door lock, and thus the automobile door is opened without the key metal or the remote key; meanwhile the method can authorize the holder of the mobile terminal and determine whether the holder is the individual car owner, thereby preventing the automobile or articles in the automobile from being stolen.

With change of the distance between the mobile terminal and the automobile, the distance is likely to exceed the effective scope of a Bluetooth connection; at the moment the user implements any operation on the mobile terminal, but the automobile door lock cannot be opened; Bluetooth connection established between the mobile terminal and the automobile are demanded for monitoring, thus the present disclosure discloses a preferred embodiment to monitor connection (as shown in FIG. 3), the mobile terminal receives the UUID transmitted by the automobile door lock, implements service discovery and characteristic discovery and establishes monitoring connection with the automobile door lock.

Thus, after the Step S102 of the first embodiment and before the Step S103, the method further includes the step of calculating the link loss of a Bluetooth connection; when the link loss is less than or equal to the preset link loss threshold, the configuration descriptors of the characteristics are amended through a Bluetooth connection to open or close the to-be-unlocked automobile door lock; when the link loss is more than the link loss threshold, the distance between the mobile terminal and the automobile exceeds the effective distance of the Bluetooth connection, and the Step S103 isn't implemented.

The mode of calculating the link loss of the Bluetooth connection is as follows: monitoring the intensity of received signals of the Bluetooth connection, and reading the transmitting power of the to-be-unlocked automobile door lock; calculating a difference value between the intensity of received signals and the transmitting power of the to-be-unlocked automobile door lock, and taking the difference value as the link loss.

### Third Embodiment

FIG. 4 shows that the embodiment of the present disclosure discloses a structure diagram of the device for controlling of opening and closing the automobile door lock through Bluetooth technology.

The embodiment discloses the device for controlling of opening and closing the automobile door lock through Bluetooth technology; the device can implement the method for controlling of opening and closing the automobile door lock through Bluetooth technology disclosed in the first embodiment of the present disclosure (as shown in the FIG. 4) and includes the following modules: a UUID receiving module 41, a Bluetooth connection establishing module 42 and a door lock switch controlling module 43.

In the embodiment of the present disclosure, the UUID receiving module 41 is used for receiving the QUID broadcast by the to-be-unlocked automobile door lock; the Bluetooth connection establishing module 42 is used for searching locking control services corresponding to the to-be-unlocked automobile door lock, characteristics of the locking control services, and configuration descriptors of the characteristics and establishing a Bluetooth connection with the to-be-unlocked automobile door lock according to the UUID; the door lock switch controlling module 43 is used for amending the configuration descriptors of the characteristics through the Bluetooth connection in order to open or close the to-be-unlocked automobile door lock.

In the Bluetooth connection establishing module 42, the mobile terminal implements service discovery through the SDP, discovers Link Loss Service and Tx power Service according to the received UUID. Characteristic descriptors of the service is discovered through Characteristic Discovery and Light Control Characteristics is configured to the Link Loss.

In the door lock switch controlling module 43, the configuration descriptors of the characteristics include: an opening descriptor and a closing descriptor; the opening descriptor may indicate that the automobile lock is in the opening state, and the closing descriptor may indicate that the automobile lock is in the closing state. In the embodiment of the present disclosure, if the configuration descriptor of the present characteristic is the opening descriptor, the configuration descriptor of the characteristic is amended into the closing descriptor on the automobile through the Bluetooth connection to close the automobile door lock; if the configuration descriptor of the present characteristic is the closing descriptor, the configuration descriptor of the characteristic is amended into the opening descriptor on the automobile through the Bluetooth connection to open the automobile door lock.

By the device for controlling of opening and closing the automobile door lock through Bluetooth technology disclosed in the embodiment of the present disclosure, Bluetooth connection between the mobile terminal and the automobile door lock is established to amend the configuration descriptors of the characteristics so as to open or close the to-be-unlocked automobile door lock, and thus the automobile door is opened without the metal key or the remote key.

### Fourth Embodiment

FIG. 5 shows that the embodiment of the present disclosure discloses a structure diagram of the device for controlling of opening and closing the automobile door lock through Bluetooth technology.

The device for controlling of opening and closing the automobile door lock through Bluetooth technology in the embodiment can implement the method for controlling of opening and closing the automobile door lock through Bluetooth technology disclosed in the first embodiment (as shown in FIG. 5) and includes the following modules: a UUID receiving module 51, a Bluetooth connection establishing module 52, a fingerprint receiving module 53, a fingerprint comparing module 54 and a door lock switch controlling module 55.

The UUID receiving module 51 is used for receiving the UUID broadcast by the to-be-unlocked automobile door lock; the Bluetooth connection establishing module 52 is used for searching locking control services corresponding to the to-be-unlocked automobile door, characteristics of the locking control services, and configuration descriptors of the characteristics, and establishing a Bluetooth connection with the to-be-unlocked automobile door according to the UUID; the fingerprint receiving module 53 is used for receiving fingerprints registered by users; the fingerprint comparing module 54 is used for comparing the fingerprints with the pre-stored fingerprints; if the similarity of the fingerprints and the pre-stored fingerprints is more than the threshold, the configuration descriptors of the characteristics are amended through the Bluetooth connection to open or close the to-be-unlocked automobile door lock; the door lock switch controlling module 55 is used for amending the configuration descriptors of the characteristics through the Bluetooth connection to open or close the to-be-unlocked automobile door lock.

In the fingerprint comparing module 54, the pre-stored fingerprints are the fingerprints pre-stored in the mobile terminal by the individual car owners. If the similarity of the fingerprints and the pre-stored fingerprints is more than or equal to the threshold, namely the users of inputting the fingerprints are the individual car owners; if the similarity of the fingerprints and the pre-stored fingerprints is lower than the threshold, namely the users of inputting the fingerprints are not the individual car owners.

By the device for controlling of opening and closing the automobile door lock through Bluetooth technology disclosed in the embodiment of the present disclosure, Bluetooth connection between the mobile terminal and the automobile door lock is established to amend the configuration descriptors of the characteristics so as to open or close the automobile door lock, and thus the automobile door is opened without the key metal or the remote key meanwhile the device can authorize the holder of the mobile terminal and determine whether the holder is the individual car owner, thereby preventing the automobile or articles in the automobile from being stolen.

With respect to the preferred embodiment of the present disclosure, on the basis of the device for controlling of opening and closing the automobile door lock through Bluetooth technology disclosed in the first embodiment of the present disclosure, the device for controlling of opening and closing the automobile door lock through Bluetooth technology disclosed in the present embodiment of the present disclosure further includes:

A link loss calculating module for calculating the link loss of the Bluetooth connection; when the link loss is less than or equal to the preset link loss threshold, the configuration descriptors of the characteristics are amended through the Bluetooth connection to open or close the to-be-unlocked automobile door lock.

The link loss calculating module includes: a received signal intensity monitoring unit for monitoring the received signal intensity of the Bluetooth connection and reading the transmitting power of the to-be-unlocked automobile door lock; a link loss calculating unit for calculating a difference value between the intensity of received signals and the transmitting power of the to-be-unlocked automobile door lock, and taking the difference value as the link loss.

The Bluetooth connection between the mobile terminal and the automobile door lock is monitored, thereby preventing the mobile terminal from being operated by the user due to the excessive link loss and interrupted Bluetooth connection.

The described device embodiment is only schematic, Wherein units described as separating parts may or may not be physically separated, and unit displaying parts may or may not be physically separated, that is, can be positioned at the same position or distributed to multiple network units. According to actual demands, the purpose of the solution in the present embodiment is realized by choosing all or some modules. The ordinary technicians in the art can understand and implement the embodiment in the absence of creative work.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

For example, FIG. 6 illustrates a block diagram of an electronic device for executing the Method according the disclosure. Traditionally, the electronic device includes a processor 610 and a computer program product or a computer readable medium in form of memory 620. The memory 620 could be :electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory units as shown in reference FIG. 7. The memory units may be provided with memory sections, memory spaces, etc., similar to the memory 620 of the server as shown in FIG. 6. The program codes may be compressed for example in an appropriate form. Usually, the memory unit includes computer readable codes 631′ which can be read for example by processors 610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it is illustrated that the above embodiments are only used for describing the technical solution of the present solution and are not affirmed to be restricted to the technical solution; the present disclosure is described in details according to the above-mentioned embodiments, thus the ordinary technicians in the art shall understand that technical solutions recorded in each embodiment still can be amended or some technical characteristics thereof can be substituted equally; these amendments or substitutions don't make the essence of the corresponding technical solution break away from the spirit and scope of the technical solution in each embodiment of the present disclosure.

What is claimed is:

1. A method for controlling of opening and closing an automobile door lock through a Bluetooth technology, comprising:
receiving a UUID broadcast by a to-be-unlocked automobile door lock, by a mobile terminal;
configuring locking control services corresponding to the to-be-unlocked automobile door, characteristics of the locking control services, and configuration descriptors of the characteristics, and establishing a Bluetooth connection with the to-be-unlocked automobile door, according to the UUID; and
amending the configuration descriptors of the characteristics through the Bluetooth connection to open or close the to-be-unlocked automobile door lock.

2. The method according to claim 1, wherein before amending the configuration descriptors of the characteristics through the Bluetooth connection to open or close the to-be-unlocked automobile door lock, the method further comprises:
receiving fingerprints registered by users;
comparing, the fingerprints with the pre-stored fingerprints; and if the similarity of the fingerprints and the pre-stored fingerprints exceeds a threshold, the configuration descriptors of the characteristics are amended through the Bluetooth connection to open or close the to-be-unlocked automobile door lock.

3. The method according to claim 1, wherein the configuration descriptors of the characteristics include: an opening descriptor and a closing descriptor;
amending the configuration descriptors of the characteristics through the Bluetooth connection to open or close the to-be-unlocked automobile comprises:
if the configuration descriptor of the present characteristic is the opening descriptor, the configuration descriptor of the characteristic is amended into the closing descriptor through the Bluetooth connection to close the automobile door lock; and
if the configuration descriptor of the present characteristic is the closing descriptor, the configuration descriptor of the characteristic is amended into the opening descriptor through the Bluetooth connection to open the automobile door lock.

4. The method according to claim 1, wherein before amending the configuration descriptors of the characteristics through the Bluetooth connection to open or close the to-be-unlocked automobile door lock, the method fulfiller comprises:
calculating link loss of the Bluetooth connection; and
when the link loss is lower than or equal to a preset link loss threshold, the configuration descriptors of the characteristics are amended through the Bluetooth connection to open or close the to-be-unlocked automobile door lock.

5. The method according to claim 4, wherein calculating link loss of the Bluetooth connection comprises:
monitoring the intensity of received signals of the Bluetooth connection, and reading transmitting power of the to-be-unlocked automobile door lock; and
calculating a difference value between the intensity of received signals and the transmitting power of the to-be-unlocked automobile door lock, and taking the difference value as the link loss.

6. An electronic device for controlling of opening and closing an automobile door lock through a Bluetooth technology, comprising:
at least one processor; and
a memory communicably connected with the at least one processor for storing instructions executable by the at least one processor, wherein execution of the instructions by the at least one processor causes the at least one processor to:
receive the UUID broadcast by the to-be-unlocked automobile door lock;
configure locking control services corresponding to the to-be-unlocked automobile door, characteristics of the locking control services, and configuration descriptors of the characteristics, and establish a Bluetooth connection with the to-be-unlocked automobile door, according to the UUID; and
amend the configuration descriptors of the characteristics through the Bluetooth connection to open or close the to-be-unlocked automobile door lock.

7. The electronic device according to claim 6, wherein execution of the instructions by the at least one processor causes the at least one processor to further:
receive fingerprints registered by users; and
compare the fingerprints with the pre-stored fingerprints; if the similarity of the fingerprints and the pre-stored fingerprints exceeds a threshold, amend the configuration descriptors of the characteristics through the Bluetooth connection to open or close the to-be-unlocked automobile door lock.

8. The electronic device according to claim 6, wherein the configuration descriptors of the characteristics include: an opening descriptor and a closing descriptor;
amend the configuration descriptors of the characteristics through the Bluetooth connection to open or close the to-be-unlocked automobile door lock comprises: if the configuration descriptor of the present characteristic is the opening descriptor, amending the configuration descriptor of the characteristic into the closing descriptor through the Bluetooth connection to close the automobile door lock; if the configuration descriptor of the present characteristic is the closing descriptor, amending the configuration descriptor of the characteristic into the opening descriptor through the Bluetooth connection to open the automobile door lock.

9. The electronic device according to claim 6, wherein execution of the instructions by the at least one processor causes the at least one processor to further:
calculate the hulk loss of the Bluetooth connection; when the link loss is less than or equal to the preset link loss threshold, amend the configuration descriptors of the characteristics through the Bluetooth connection to open or close the to-be-unlocked automobile door lock.

10. The electronic device according to claim 9, wherein calculate the link loss of the Bluetooth connection comprises:
monitoring the received signal intensity of the Bluetooth connection and reading the transmitting power of the to-be-unlocked automobile door lock; and
calculating a difference value between the intensity of received signals and the transmitting power of the to-be-unlocked automobile door lock, and taking the difference value as the link loss.

11. A non-transitory computer readable medium having computer programs stored thereon that, when executed by one or more processors of an electronic device, cause the electronic device to perform operations including:
receiving a UUID broadcast by a to-be-unlocked automobile door lock, by a mobile terminal;
configuring locking control services corresponding to the to-be-unlocked automobile door, characteristics of the locking control services, and configuration descriptors of the characteristics, and establishing a Bluetooth connection with the to-be-unlocked automobile door, according to the UUID; and
amending the configuration descriptors of the characteristics through the Bluetooth connection to open or close the to-be-unlocked automobile door lock.

12. The non-transitory computer readable medium according to claim 11, wherein the electronic device is further caused to:
receive fingerprints registered by users; and
compare the fingerprints with the pre-stored fingerprints; if the similarity of the fingerprints and the pre-stored fingerprints exceeds a threshold, amend the configuration descriptors of the characteristics through the Bluetooth connection to open or close the to-be-unlocked automobile door lock.

13. The non-transitory computer readable medium according to claim 11, wherein the configuration descriptors of the characteristics include: an opening descriptor and a closing descriptor;
amend the configuration descriptors of the characteristics through the Bluetooth connection to open or close the to-be-unlocked automobile door lock comprises: if the configuration descriptor of the present characteristic is the opening descriptor, amending the configuration descriptor of the characteristic into the closing descriptor through the Bluetooth connection to close the automobile door lock; if the configuration descriptor of the present characteristic is the closing descriptor, amending the configuration descriptor of the characteristic into the opening descriptor through the Bluetooth connection to open the automobile door lock.

14. The non-transitory computer readable medium according to claim 11, wherein the electronic device is further caused to:
calculate the link loss of the Bluetooth connection; when the link loss is less than or equal to the preset link loss threshold, amend the configuration descriptors of the characteristics through the Bluetooth connection to open or close the to-be-unlocked automobile door lock.

15. The non-transitory computer readable medium according to claim 14, wherein calculate the link loss of the Bluetooth connection comprises:
monitoring the received signal intensity of the Bluetooth connection and reading the transmitting power of the to-be-unlocked automobile door lock; and
calculating a difference value between the intensity of received signals and the transmitting power of the to-be-unlocked automobile door lock, and taking the difference value as the link loss.
